(19) United States
(12) Patent Application Publication
(10) Pub. No.: US 2004/0041840 A1
(43) Pub. Date: Mar. 4, 2004

(54) System and method for process dependency management

(76) Inventors: Brett Green, Meridian, ID (US); Curtis Reese, Boise, ID (US); Daniel Travis Lay, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/228,658

(22) Filed: Aug. 27, 2002

(51) Int. Cl. G09G 5/00

(52) U.S. Cl. 345/776; 345/805

(57) ABSTRACT

A process and service dependency management system is provided that is used within an operating system environment. The system includes an executing services module containing a list of service processes that are currently executing in the operating system environment. An executing processes module is included that contains a list of service requesting processes executing in the operating system environment. A display structure links an individual service process from the list of services processes to service requesting processes from the list of service requesting processes. The display structure is configured to display a relationship between the service requesting processes and the individual service process, wherein the service requesting processes call the individual service process to receive services.

### FIELD OF THE INVENTION

The present invention relates generally to managing processes in an operating system environment.

### BACKGROUND

When a user runs an application or program on a computer, the user is actually requesting the operating system to load and execute one or more processes associated with that application. For example, an application can have a primary process that is loaded initially and additional auxiliary processes which may be loaded as needed.

From the point that applications load, the user expects to be able to constantly and quickly interact with each application whenever they desire. This constant interaction is frequently possible when just a small amount of processing is performed between user events, such as a button click or a menu item request in the application. For example, a word processor performs most of its processing in small chunks and the user is able to access the user interface seemingly instantaneously.

Other applications may not be available to the user for a certain period after the user has requested a complex or time-consuming operation. The period may be a few seconds or sometimes longer. Some applications and processes are able to present the user with a screen that notifies a user of the status of their request. Unfortunately, many processes cannot provide this status. This is especially true where the process running on the user's side has requested information from a process running on a remote server or database. In these situations, the process will make its request and then appear to freeze as the request is performed remotely from the local machine.

Even when an application presents a screen to the user and tells the user that the application or process is busy performing operations, the user may not know whether the service request is being processed or whether the application has crashed. This is especially true for an application that is not able to present a user with a progress screen. The user interface in such a situation will appear to be frozen but the application will actually be performing normal processing behind the scenes. Either the user must be patient in this situation or the user can decide to try to terminate the application or process. To terminate an application's processes, the user opens the operating system's task manager and requests that the specific processes terminate immediately.

If the user decides to terminate a process, this can be a problem in many situations because the process is not allowed to shutdown normally when a user termination is initiated. This means that the normal cleanup and shutdown functions cannot be activated. Of course, there are legitimate situations where processes should be terminated. A process should be terminated when it has crashed or there has been a process or system malfunction. In these cases, the process should be stopped and restarted.

If the process is still working, then the user generally does not want to terminate the process because at some point the process will complete the task that the user has requested. Terminating a process prematurely can cause serious problems for the process or the entire system. Terminating the process prematurely can cause corruption in the process itself and cause corruption to other processes or a service from which the original process has requested information. One situation where this might happen is a process that is requesting information from or trying to write to a database. If the process is writing the information to the database and then the process is prematurely terminated, the database may be corrupted and/or left in a partially completed state.

In current operating systems, the user can see some status indicators for processes as they are running in the operating system. Most operating systems can tell the user that the operating system believes a process is currently running according to normal process criteria. The operating system may also tell the user that the process is currently sleeping. In this situation, the operating system believes that the process is waiting for a requested function but the operating system does not know what that function is. In other situations, the operating system will state that the process is busy or not responding to the operating system.

In the situations described previously, it is difficult for a user to know whether they should terminate the process or wait. The process may appear to be busy to the operating system but the process may have actually crashed. If so, how much time should the user wait before the user determines that they should terminate that process? In a similar manner, if the process is not responding, the user may suppose that the process will never respond or perhaps it will actually respond but it may not be for some time. In either of these cases, the process may be shutdown prematurely by the user causing memory corruption, database problems, or other bad system side effects.

In addition to the problems and side effects associated with a process being terminated prematurely, the user must be careful which process types are terminated. Current operating systems list all of the running processes together in the same list and the user has access to terminate any process without warning. A user may even accidentally terminate a process by mistaking it for another process or another type of process. Most users have no idea whether they are terminating an application process they have started or whether they are going to terminate a service process that the operating system needs for multiple applications.

For example, if a user shuts down a word processing process they have started, this is unlikely to cause any initial problems. As a result of this shutdown, the word processing process may have left behind several program parts or processes which are resident in memory that the user did not know were related to the terminated process. This creates memory fragmentation, corruption and other problems as discussed.

A more severe case exists where the user shuts down a process for an operating system service (e.g., a communications service or a network socket). This creates problems for all the processes that access that service. If a specific service is terminated, then all processes dependent upon that service will not be able to function when they require the service. This is also true of any other process that is terminated and there are other processes that depend upon the terminated process. Because a user cannot immediately identify which type of processes they want to terminate, the user runs the risk of terminating processes and applications that could cause significant damage and/or memory corruption to the local system or even the entire network.

### SUMMARY OF THE INVENTION

The invention provides a process and service dependency management system that is used within an operating system environment. The system includes an executing services module containing a list of service processes that are currently executing in the operating system environment. An executing processes module is included that contains a list of service requesting processes executing in the operating system environment. A display structure links an individual service process from the list of services processes to service requesting processes from the list of service requesting processes. The display structure is configured to display a relationship between the service requesting processes and the individual service process, wherein the service requesting processes call the individual service process to receive services.

### BRIEF DESCRIPTION OF THE DRAWINGS

FIG. 1 illustrates a process and service dependency management system that can be used within an operating system environment;

FIG. 2 illustrates an interface for a process management system that displays processes which depend upon a service in accordance with an embodiment of the present invention;

FIG. 3 is a block diagram that illustrates an embodiment of a system for displaying processes that depend upon other service processes as illustrated in the interface of FIG. 2;

FIG. 4 illustrates an interface for a process management system that displays services that are used by a given process in accordance with an embodiment of the present invention;

FIG. 5 illustrates an interface for a process management system that displays dynamic link files (DLLs) which are used by a process;

FIG. 6 illustrates an interface for a process management system that displays data files used by a process; and

FIG. 7 is a flow chart depicting an embodiment of operations for organizing, displaying and interacting with process dependencies.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention is a process management system and method for managing process dependencies, service dependencies and related dependencies. In one embodiment, the user is able to view process dependencies upon services, and the system also allows users to stop or restart services. In the past, when users have terminated a process, the effect on other processes, services, or the operating system has not always been immediately apparent. Sometimes terminating one process or service will have a significant effect on many other processes. This is a result of the interdependencies between processes, applications, services and the files used by these processes in the operating system.

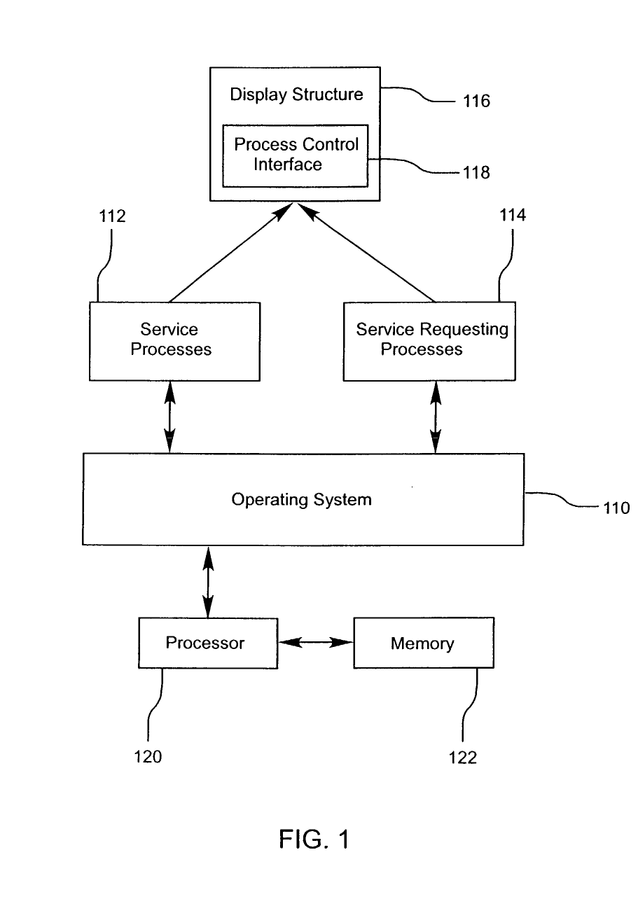

FIG. 1 illustrates a process and service dependency management system that can be used within an operating system environment. The operating system environment includes processes, services, interfaces and operating system functions that are executing on at least one processor 120 that is coupled to a memory or storage medium 122. A list of service processes 112 that are currently executing in an operating system can be retrieved by a call to the operating system 110. In addition, a list of service requesting processes 114 that are executing in the operating system environment can be retrieved from the operating system. The service requesting processes are processes which depend on certain functions from service processes. Some examples of services that may exist in the operating system are the operating system audio, graphical user interface functions, logical disk management, common object modeling, communication, and network services.

When a service process exists that is providing services to another process, then that service process must continue to execute as long as it is needed. If the service process is terminated by a user, then any process or application that depends upon the service process will not have access to the service functions that were being provided. Accordingly, dependent processes may crash as a result.

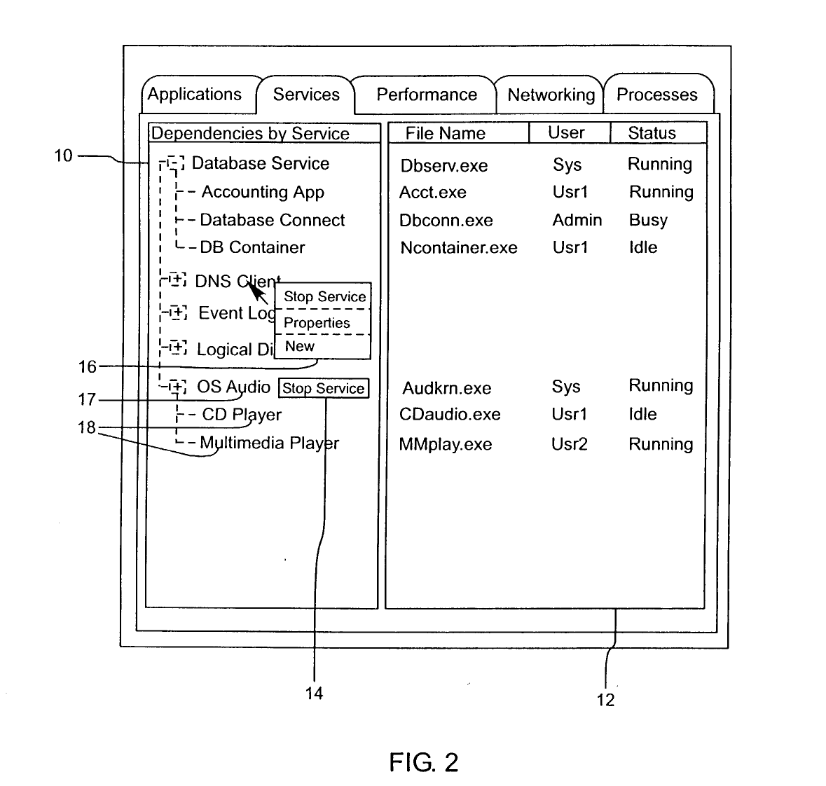

FIG. 1 further illustrates that a display structure 116 is used to display the relationship or links between an individual service process and service requesting processes. Both the individual service process 112 and the service requesting processes 114 are drawn respectively from a service process list or a service requesting process list. As illustrated in FIG. 2, the individual service process 17 (e.g., an audio process) may have a number of service requesting processes 18 (e.g., a CD player, multimedia player, etc.) which depend upon that service. If the OS audio service, as illustrated, is terminated or stopped through the process control interface 118 or task manager (FIG. 1) in the operating system, a user does not know how the service process is related to the processes which depend upon the service process. Thus, the display interface in the present invention uses a display structure that is configured to display the relationship between the service requesting processes (e.g., processes that need audio services), and the service processes (e.g., audio services).

These relationships can be displayed in a tree format 10, as in FIG. 2, to show how the service requesting processes depend upon a service process. Once the user knows that a service process has failed or is having trouble, then the user can terminate or stop that process. The process can be stopped using a graphical button through the user interface 14. Another way that a process can be stopped is by using a popup menu that is available when the user left or right clicks on the service process 16. A process that is having problems can also be restarted using this type of interface. Another way that the user can shutdown a service process is by using an independent window that pops up to separately inform the user that they can shutdown the service process. It is useful to be able to view the service requesting processes that depend upon a service process in a tree fashion because it allows the user to know every application and process that will be affected by the termination of a specific service before the user actually terminates the service process.

Although a tree display structure or tree menu is shown in FIG. 2, other types of hierarchical display structures can be used. For example, the processes which depend upon services can be shown in a spoke and hub configuration. This configuration displays the service process at the center of the hub with a number of service requesting processes as the outside of the rim with spokes connecting them to the service process. Other types of similar hierarchical display structures can also be used such as an organization chart, directed graph, or drill-down viewing system.

In addition to displaying the name of the processes which depends upon a service, it is valuable to display the executable names for the processes or services that are being viewed. Other attributes for the processes that are running within the operating system can also be displayed such as the user or the owner of the processes and the status of the processes. The status of the processes may include whether the process is running, failed, busy, idle or any other status that is available from the operating system. In some situations, the file name may just be available and there will be no descriptive name available in the hierarchical display structure or menu.

FIG. 2 also illustrates one interface embodiment for an arrangement of the process and service dependency management interface within an operating system. For example, the tree menu 10 and its associated file attributes 12 can be accessible through the operating system's process manager. Alternatively, the process and service dependency management interface can also be available through a separate services utility or through other points in the operating system where this functionality is convenient to access. A specific example of an interface point where an existing operating system can display a process manager with the configuration described above is the Microsoft Windows™ Task Manager. The tree menu can also be arranged above or below the file attributes pane or to the right of the file attributes pane.

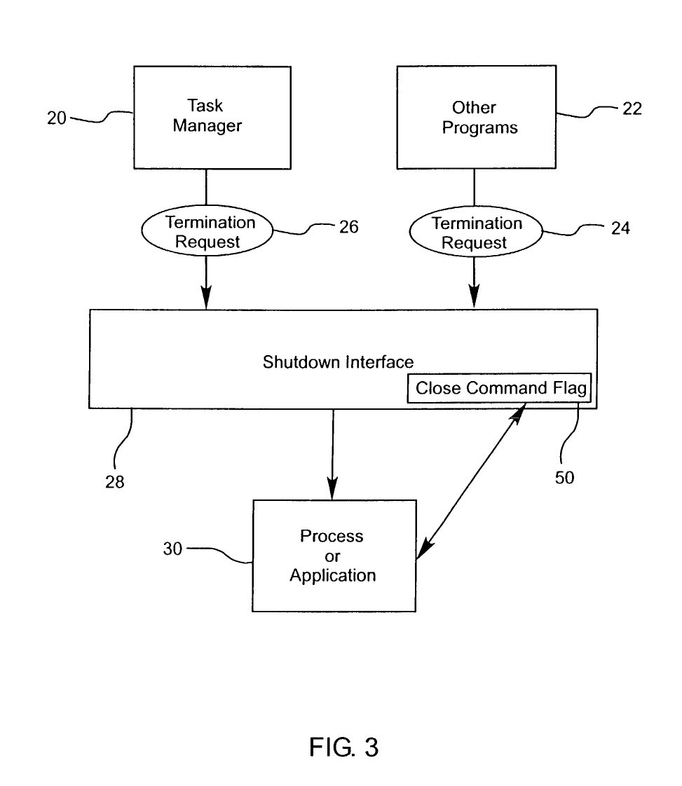

FIG. 3 illustrates a block diagram of software or hardware modules used to provide a process and service dependency management system. The dependency management system includes an executing services module 102 that can retrieve and contain a list of service processes that are currently executing in the operating system. An executing processes module 104 is included to retrieve and contain a list of service requesting processes that are currently executing the operating system. The information about the service processes or service requesting processes can be requested from operating system using the appropriate application program interface (API), procedure calls, object calls, or other known means of interacting with the operating system. Alternately, this information can be determined by interacting with the processes themselves.

A dependency linking module 106 can link together the dependent relationships between an individual service process from a list of services and a plurality of service requesting processes from the list of service requesting processes. The dependency linking module builds up a list of pointers or a dependency graph that can be used to show the relationship between the service processes and the service requesting processes. A display structure 108 is used in the process dependency management system to display the relationships or links that exist. The display structure can display the relationship between an individual service process and its related service requesting processes. A relationship is generally defined by service requesting processes that call for services from an individual service process. As mentioned in relation to FIG. 2, the service processes can provide a wide range of services within the operating system that include, but are not limited to, network services, peripheral services, display services, data storage services and similar service functions.

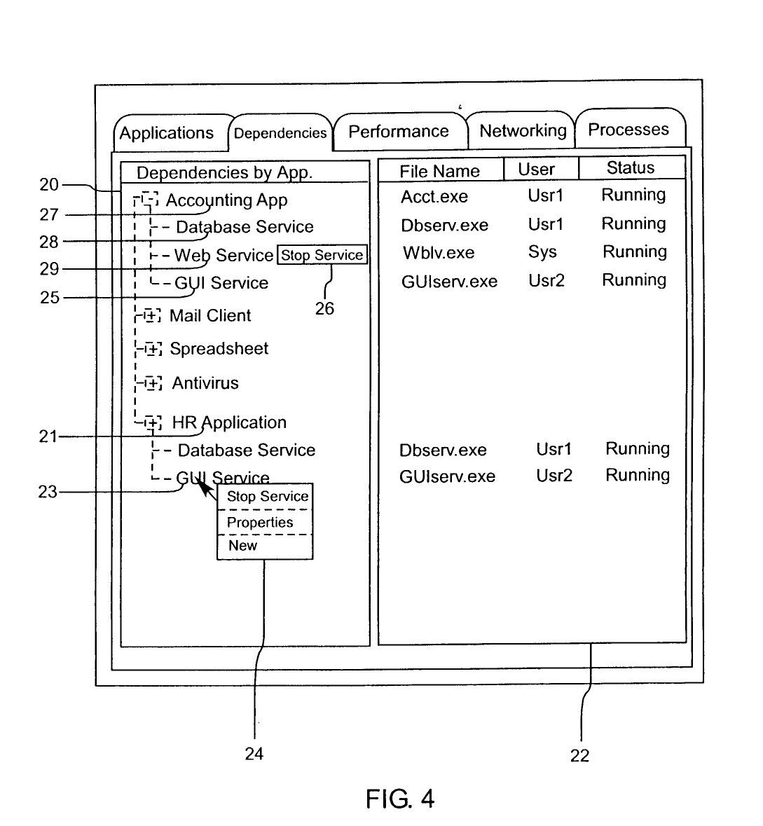

FIG. 4 illustrates a user interface that displays the service process dependencies by service requesting process or application. In other words, the service requesting process 27 is the parent node and the service processes 27-29 are the child nodes. For example, the accounting application 27 has three services processes upon which it is dependent for information services. As illustrated, the accounting application has a database service 28, a web service 29, and a GUI (Graphical User Interface) service 25 upon which it is dependent. The Human Resources (HR) application 21 is also dependent on the GUI services 23.

If an end user stops the GUI service, then both the HR application 21 and the accounting application 27 will not function properly. So, the tree display structure 20 and its accompanying file attributes 22 are useful because a user can see which applications will have problems if a service is stopped at any given time. FIG. 4 further illustrates a graphical button 26 through which the web service 29 can be stopped, started, or possibly restarted, but a popup menu may be used by the user to terminate services, if desired.

When the user terminates the GUI service 23 that is linked to the HR application, the GUI service 25 will also be stopped because it is the same service. The GUI service is shown twice in the dependency tree because it is used by more than one process. The user may realize after viewing this interface that they do not desire to terminate a specific service because it is apparent that there are several processes depending upon the service. When the user determines that they should not terminate a process, this avoids data corruption and malfunctioning applications within the operating system.

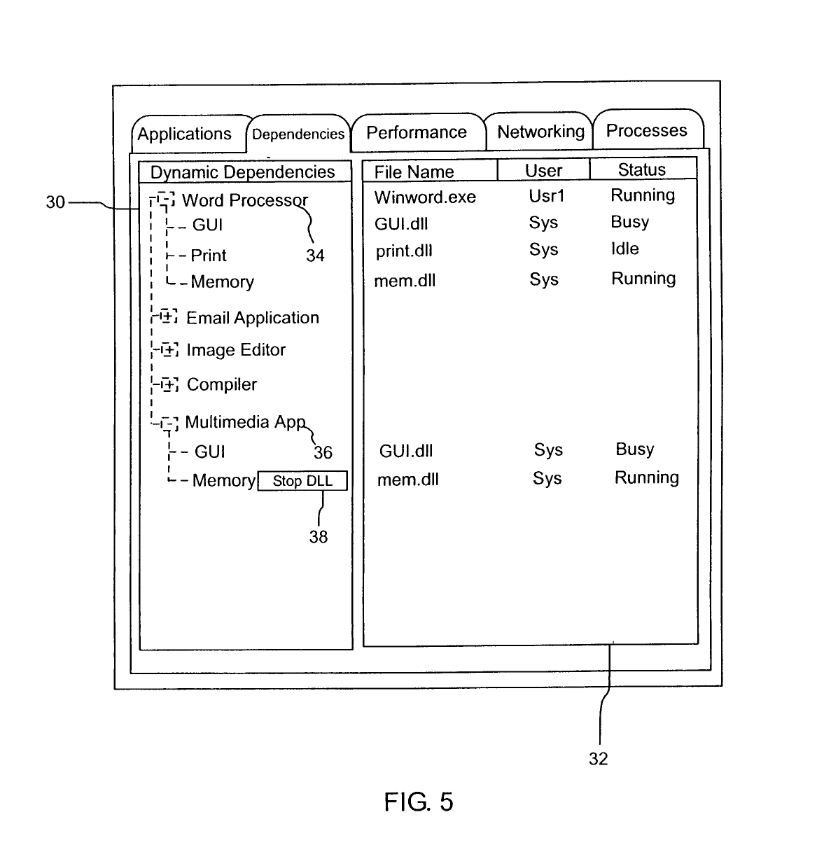

FIG. 5 illustrates the dependencies between dynamic link libraries (DLLs) and the applications or service processes that depend on them for certain processing functions. Dynamic link libraries are executable files that are loaded by the operating system and generally contain re-entrant routines that are used by multiple applications. If these reusable files have problems or crash, then this creates problems for the processes which depend on the DLLs. For example, the tree display structure 30 includes a word processing application 34 that depends on a GUI DLL, a print DLL and a memory DLL. In a similar manner, the multimedia application 36 also depends on the GUI DLL and memory DLL. If the user decides to stop the memory DLL so that it can be reloaded, the user can click the graphic interface button 38 to stop the DLL. In so doing, the user can also see that stopping the memory DLL will also stop this dynamic link library for the word processor. Alternative methods can be used to stop the dynamic link libraries such as popup menus or independent windows that are loaded upon activation of a GUI control. These dependencies can also be shown in a format where the DLLs are the parent node and the dependent processes are shown as child nodes.

Once the dependencies are identified between the service processes and service requesting processes or DLLs, then the data about the relationships between the processes can be utilized. When a process, service, or DLL is terminated, the system can examine which other processes, services or DLLs were dependent on the terminated process. The examination can take place as part of the process termination procedure or through a separate dependency checking process which is a background utility launched when a process is terminated. This procedure or background utility process can check the links or relationships between the processes to determine how the terminated process(es) have affected the dependencies.

Then a message can be sent to the user informing them that certain processes or DLLs, which were dependent upon a previously terminated process, remain in the operating system. At that point, the user can be given the option to terminate these dependent processes or DLLs that are likely to have problems. Alternately, the system can automatically go through and terminate processes, services or DLLs which were dependent upon the terminated process, service, or DLL. Stopping processes or DLLs that were dependent on a terminated process helps ensure that only properly behaving services are running within the operating system and it makes the operating system more stable.

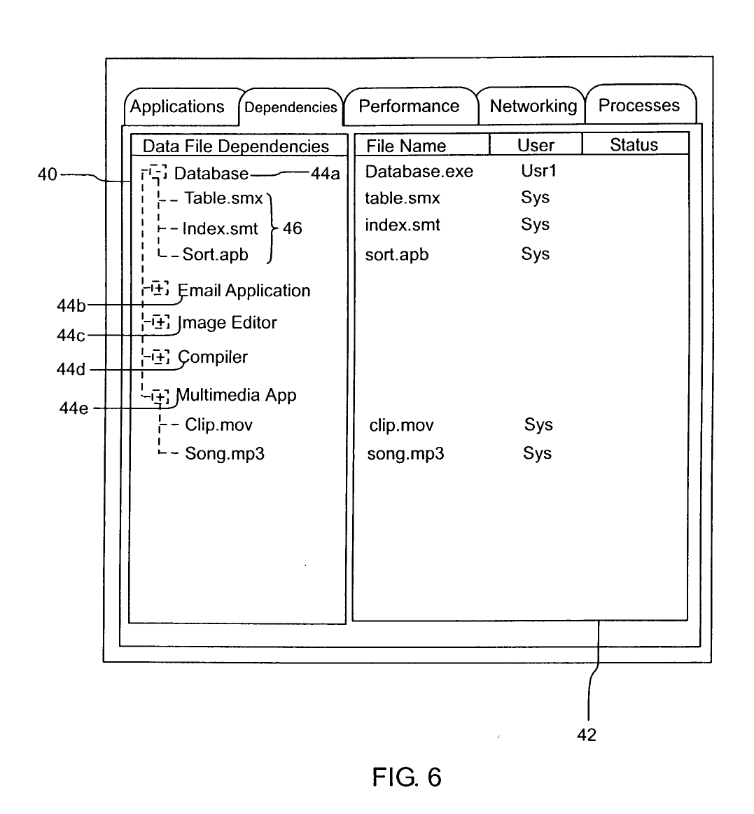

FIG. 6 illustrates a system and method for managing data file dependencies for processes within an operating system environment. At the highest level of the tree display structure 40 is the list of processes 44a-e that are currently executing in the operating system. A list of data files 46 accessed by each process can be displayed in the tree display structure. Using a hierarchical display structure allows the individual who is viewing the applications to see which data files the application is dependent upon. One advantage of seeing data file dependencies is that a user will know what files the process is using and that the files may be corrupted if the process is terminated. The data file dependency of FIG. 6 can also be included with the service dependencies of FIGS. 1 and 3. Below each service or application, the dependent data files can also be listed in a hierarchical data structure or tree display structure.

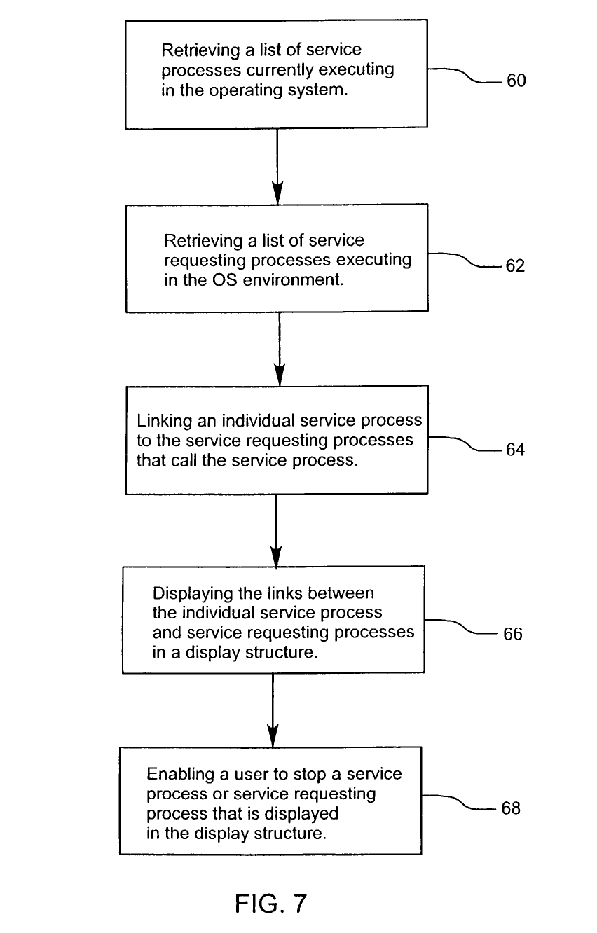

FIG. 7 illustrates system operations and a method for managing processes and services that have interdependencies within an operating system environment. The method includes the operation of retrieving a list of service processes that are currently executing in the operating system at block 60. Another operation is retrieving a list of service requesting processes executing in the operating system environment at block 62. An individual service process is linked to its service requesting processes from the list of service requesting processes at block 64. A further operation is displaying the linking between the individual service process and the service requesting processes in a display structure at block 66. An optional operation is enabling a user to stop the individual service process or the service requesting processes displayed in the display structure at block 68.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A process and service dependency management system that is used within an operating system environment, comprising:
an executing services module containing a list of service processes that are currently executing in the operating system environment;
an executing processes module containing a list of service requesting processes executing in the operating system environment; and
a display structure that relates an individual service process from the list of service processes to service requesting processes from the list of service requesting processes, and the display structure is configured to display a relationship between the service requesting processes and the individual service process, wherein the service requesting processes call the individual service process to receive services.

2. A system as in claim 1, further comprising a process control interface that enables a user to terminate individual service processes or individual service requesting processes that are displayed in the display structure.

3. A system as in claim 2, wherein the process control interface further includes a process control interface selected from the group of process control interfaces consisting of a graphical button, a pop-up menu, and an independent window.

4. A system as in claim 1, wherein the display structure is a hierarchical display structure.

5. A system as in claim 4, wherein the display structure is a tree display structure.

6. A system as in claim 1, further comprising a task manager through which the display structure is accessed.

7. A system as in claim 1, further comprising a services manager through which the display structure is accessed.

8. A system as in claim 1, further comprising a dependency checking process configured to remove processes that are dependent upon a terminated process.

9. A system as in claim 8, wherein the dependency checking process can remove DLLs that are dependent upon a terminated process.

10. A system as in claim 1, further comprising a process control interface that enables a user to restart individual service processes or individual service requesting processes that are displayed in the display structure.

11. A process and service dependency management system that is used within an operating system environment, comprising:
an executing services module containing a list of service processes that are currently executing in the operating system environment;
an executing processes module containing a list of service requesting processes executing in the operating system environment; and
a display structure that links an individual service requesting process from the list of service requesting processes to service processes from the list of services processes, and the display structure is configured to display a relationship between the service requesting process and the service processes that provide services to the service requesting process, wherein the service requesting process is displayed as a parent node and the service processes are displayed as child nodes.

12. A method for managing processes and services that have dependencies within an operating system environment, comprising the steps of:
retrieving a list of service processes that are currently executing in the operating system;
retrieving a list of service requesting processes executing in the operating system environment; and
linking an individual service process from the list of service requesting processes to service requesting processes from the list of service requesting processes, to represent relationships for service requesting processes that call the individual service process and receive services from the individual service process;
displaying the relationships between the individual service process and the service requesting processes in a display structure.

13. A method as in claim 12, further comprising the step of enabling a user to terminate the individual service process or service requesting processes displayed in the display structure.

14. A method as in claim 12, further comprising the step of enabling a user to terminate the individual service process or service requesting processes using an interface selected from the group of interfaces consisting of a graphical button, a pop-up menu and an independent window.

15. A method as in claim 12, wherein the step of displaying the relationships further comprises the step of displaying the relationships between the individual service process and the service requesting processes in a hierarchical display structure.

16. A method as in claim 12, wherein the step of displaying the relationships further comprises the step of displaying the relationships between the individual service process and the service requesting processes in a tree structure.

17. A method as in claim 12, further comprising the step of linking data files to corresponding individual service processes from the list of service processes.

18. A method as in claim 12, further comprising the step of linking data files to the service requesting processes from which the data file depends.

19. A method as in claim 18, further comprising the step of notifying a user that a data file may be corrupted if the service requesting process is terminated.

20. A method as in claim 12, further comprising the step of removing processes that are dependent upon a terminated process.

21. A method as in claim 12, further comprising the step of removing DLLs that are dependent upon a terminated process.

22. A method as in claim 12, further comprising the step activating a dependency checking process that executes and removes processes that are dependent upon a terminated process.

23. A method for managing data file dependencies for processes within an operating system environment, comprising the steps of:
retrieving a list of processes that are currently executing in the operating system;
retrieving a list of data files that are being accessed by an individual process from the list of processes in the operating system environment;
linking the individual process to the list of data files being accessed by the individual process to form relationships; and
displaying relationships between the individual process and the list of data files being accessed by the individual process in a display structure.

24. A method as in claim 23, wherein the step of displaying the relationships further comprises the step of displaying the relationships between the individual process and the list of data files being accessed by the process in a display structure which is a hierarchical display structure.

25. A method as in claim 24, wherein the step of displaying the relationships further comprises the step of displaying the relationships between the individual process and the list of data files being accessed by the process in a display structure which is a tree display structure.

26. An article of manufacture, comprising:
a computer usable medium having computer readable program code embodied therein for managing processes and services that have dependencies within an operating system environment, the computer readable program code in the article of manufacture comprising:
computer readable program code for retrieving a list of service processes that are currently executing in the operating system;
computer readable program code retrieving a list of service requesting processes executing in the operating system environment;
computer readable program code for linking an individual service process from the list of service requesting processes to service requesting processes from the list of service requesting processes, to provide links for service requesting processes that call the individual service process and receive services from the individual service process; and
computer readable program code for displaying the links between the individual service process and the service requesting processes in a display structure.

27. An article of manufacture as in claim 26, further comprising computer readable program code for enabling a user to terminate the individual service process or service requesting processes displayed in the display structure.

28. A process and service dependency management system that is used within an operating system, comprising:
an executing services means for containing a list of service processes executing in the operating system;
an executing processes means for containing a list of service requesting processes executing in the operating system; and
a display means for relating an individual service process from the list of services processes to service requesting processes from the list of service requesting processes, and the display means is configured for displaying a relationship between service requesting processes that call the individual service process to receive services from the individual service process.

29. A system as in claim 28, further comprising a process control means that enables a user to terminate the individual service process or an individual service requesting process that is displayed.

30. A system as in claim 28, further comprising a process control means that enables a user to restart the individual service process or an individual service requesting process that is displayed.
